(19) United States
(12) Patent Application Publication
(10) Pub. No.: US 2010/0128045 A1
(43) Pub. Date: May 27, 2010

(54) DISPLAY CONTROL APPARATUS, DISPLAY CONTROL METHOD, AND PROGRAM THEREFOR

(76) Inventors: Shinji Inamoto, Tokyo (JP); Ryo Sakuma, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/623,349

(22) Filed: Nov. 20, 2009

(30) Foreign Application Priority Data
Nov. 27, 2008 (JP) P2008-302339

(51) Int. Cl. G09G 5/36

(52) U.S. Cl. 345/545

(57) ABSTRACT

A display control apparatus causing an image corresponding to image data having been written into a front buffer to be displayed on a display includes a decoder decoding encoded image data and writing the decoded image data into a back buffer in groups of pieces of image data of a first size of data, and a transferring section reading out image data in groups of pieces of image data of a second size of data from among the image data having been written into the back buffer, and transferring the read-out image data into the front buffer, and the back buffer is a ring buffer including an area resulting from connection of a secondary area having a storage capacity determined on the basis of the second size of data and a plurality of primary areas each having a storage capacity at least the same as the first size of data.

### BACKGROUND OF THE INVENTION

1. Field of the Invention

The present invention relates to display control apparatuses, display control methods, and programs therefor, and in particular, it relates to a display control apparatus, a display control method, and a program therefor, which are suitable for use when updating displays on a display device by transferring image data stored in a back buffer into a front buffer to perform updating thereof.

2. Description of the Related Art

Displaying of images on a display device is performed so that image data is written into a buffer included in video random access memory (VRAM), and then, the image data that has been written in the buffer is reflected in displays on a display device. Therefore, improper control of timings at which the image data that has been written into the buffer included in the VRAM is reflected in displays on the display device is likely to leads to situations in which incomplete images corresponding to image data stored in the buffer, which has not yet been updated or is in process of being updated, are displayed on the display device.

In order to suppress occurrence of such a situation, to date, a technology has been provided that allows the VRAM to include two kinds of buffers, one being a back buffer used for processes performed with respect to image data for the purpose of displaying images corresponding to the image data, the other one being a front buffer used for processes with respect to image data performed for the purpose of reflecting the image data in displays on a display device. Here, the foregoing processes performed with respect to image data for the purpose of displaying images corresponding to the image data include, for example, a process of decoding (decompressing) compression-encoded image data, further, a process of writing the resultant decoded image data into the back buffer, and the like.

Further, allowing image data stored in the back buffer to be rapidly transferred into the front buffer suppresses displaying of incomplete images corresponding to image data in the process of being written into the front buffer on a display device.

However, the forgoing existing technology has disadvantages in that it is necessary to reserve an area of a size approximately the same as that of the front memory in the VRAM or in a main memory as the back buffer, and further, it takes a large amount of latency time for image data stored in the back buffer to be transferred into the front buffer.

Accordingly, as shown in an example of FIG. 1, inventors of the present invention have already proposed a method, in which a back buffer of a height Y smaller than that of a front buffer is reserved, and the all pieces of image data are transferred into the front buffer by iterating a series of processes a plurality of times, in which, from among the all the pieces of image data, segmented pieces of image data including X lines subsequent to an immediately previously selected segmented pieces of image data are selected and written into the back buffer, and from among the pieces of image data which have been written into the back buffer, segmented pieces of image data including Y lines (Y=X) are transferred into the front buffer (refer to Japanese Unexamined Patent Application Publication No. 2007-86432).

In addition, hereinafter, transferring image data stored in a back buffer into a front buffer will be referred to as updating of a front buffer.

Further, in Japanese Unexamined Patent Application Publication No. 2007-86432, inventors have proposed a method, in which, when updating the front buffer by transferring segmented pieces of image data from the back buffer into the front buffer, the segmented pieces of image data are enlarged or reduced. For example, as shown in FIG. 2, assuming that Y and Z are defined as follows: Y being the number of lines of each group of pieces of image data with which image data is read out from the back buffer, Z being the number of lines of each partitioned area into which pieces of image data including Y lines are written, in the case of enlarging image data, the numbers of lines Y and Z are set so as to be in accordance with an enlargement ratio and make the number of lines Y smaller than the number of lines Z.

In contrast, in the case of reducing image data, the numbers of lines Y and Z are set so as to be in accordance with a reduction ratio and make the number of lines Y larger than the number of lines Z. Obviously, setting performed so that the number of lines Y is equal to the number of lines Z enables updating of the front buffer by using image data being subjected to neither enlarging processing nor reducing processing, that is, being of an original size.

However, depending on an enlargement ratio (or a reduction ratio) with respect to image data, values of coordinates of image data resulting from performing processing for enlarging (or reducing) are unlikely to be integers. Further, converting of these non-integers indicating coordinates into integers by performing rounding of fractional parts of the non-integers causes misalignments from the enlargement ratio (or the reduction ratio), and as a result, leads to reduction of the quality of images.

Therefore, in the invention disclosed in Japanese Unexamined Patent Application Publication No. 2007-86432, in order to prevent occurrence of the misalignments from the enlargement ratio (or the reduction ratio), the number of lines Y is adjusted so as to make the values of the coordinates of transferred image data integers. Accordingly, this method makes the values of the coordinates of the transferred image data integers, and prevents occurrence of misalignments from the enlargement ratio (or the reduction ratio), and thus, enables prevention of reducing the quality of images.

### SUMMARY OF THE INVENTION

Here, in Japanese Unexamined Patent Application Publication No. 2007-86432 described above, processing is performed on the assumption that the number of lines X of each group of pieces of image data with which image data is written into the back buffer corresponds to the number of lines Y of each group of image data with which image data is read out from the back buffer. In this case, it is sufficient for a circuit provided at a prior stage of the back buffer, such as a decoder configured to decompress compression-encoded image data, to be just capable of outputting image data in groups of pieces of image data including any lines so that the number of lines X corresponds to the number of lines Y, that is, X=Y.

However, assuming that a decoder is provided as the circuit located at the front stage of the back buffer and the decoder is configured by using hardware components, sometimes, the number of lines X of each group of pieces of image data with which the decoder is capable of outputting image data is limited, and thus, a situation, in which it is difficult for the decoder to output image data in groups of pieces of image data including any lines, the number X of which corresponds to the number of lines Y, that is, X=Y, is likely to arise. In such a case, it is necessary to provide a configuration which enables the number of lines X of each group of pieces of image data with which image data is written into the back buffer, and the number of lines Y of each group of pieces of image data with which image dada is read out from the back buffer to be set independently.

Accordingly, it is desirable to provide a display control apparatus including a method which enables two series of control to be performed independently, one being a series of control performed for processes of writing image data into a back buffer, the other one being a series of control performed for processes of reading out image data from the back buffer.

In display control apparatuses each causing an image corresponding to image data having been written into a front buffer to be displayed on a display device, a display control apparatus according to an embodiment of the present invention includes a decoder configured to decode encoded image data and write image data resulting from decoding of the encoded image data into a back buffer in groups of pieces of data of a first size of data, and a transferring section configured to read out image data in groups of pieces of a second size of data from among the image data having been written into the back buffer in groups of pieces of data of the first size of data, and transfer the read-out image data into the front buffer, and further, the back buffer is a ring buffer including a buffering area resulting from connection of a secondary area having a storage capacity determined on the basis of the second size of data and a plurality of primary areas each having a storage capacity at least the same as the first size of data.

The foregoing transferring section is configured to read out image data in groups of pieces of data of the second size of data from among the image data, having been written into the primary areas of the back buffer and including successively located pieces of image data, the size of which is more than or equal to the second size of data, and transfer the read-out image data into the front buffer.

The foregoing transferring section is configured to, in the case where the image data having been written into the primary areas of the back buffer includes successively located pieces of image data, the size of which is less than the second size of data, transfer the image data including successively located pieces of image data, the size of which is less than the second size of data, into a backmost portion of the secondary area, and read out image data in groups of pieces of data of the second size of data from among the image data having been written into the secondary area and the primary areas and including successively located pieces of image data, the size of which is more than or equal to the second size of data, and transfer the read-out image data into the front buffer.

The transferring section is configured to read out image data in groups of pieces of data of the second size of data from among the image data having been written into the back buffer in groups of pieces of data of the first size of data, further, convert the read-out image data into image data of a third size of data, and transfer the converted image data into the front buffer.

The decoder is configured to be controlled by an application program, and the transferring section is configured to be controlled independently from the application program by middleware invoked by the application program.

In display control methods included in display control apparatuses each causing an image corresponding to image data having been written into a front buffer to be displayed on a display device, a display control method according to an embodiment of the present invention includes the steps of decoding encoded image data, writing image data resulting from decoding of the encoded image data into a back buffer in groups of pieces of data of a first size of data, reading out image data in groups of pieces of data of a second size of data from among the image data, having been written into the back buffer in groups of pieces of data of the first size of data, and transferring the read-out image data into the front buffer, and further, the back buffer is a ring buffer including a buffering area resulting from connection of a secondary area having a storage capacity determined on the basis of the second size of data and a plurality of primary areas each having a storage capacity at least the same as the first size of data.

A program according to an embodiment of the present invention is a program performing control of a display control apparatus which causes an image corresponding to image data having been written into a front buffer to be displayed on a display device, and causes a computer included in the display control apparatus to execute a process including the steps of decoding encoded image data, writing image data resulting from decoding of the encoded image data into a back buffer in groups of pieces of data of a first size of data, reading out image data in groups of pieces of data of a second size of data from among the image data having been written into the back buffer in groups of pieces of data of the first size of data, and transferring the read-out image data into the front buffer, and further, the back buffer is a ring buffer including a buffering area resulting from connection of a secondary area having a storage capacity determined on the basis of the second size of data and a plurality of primary areas each having a storage capacity at least the same as the first size of data.

According to an embodiment of the present invention, encoded image data is decoded, and image data resulting from decoding of the encoded image data is written into a back buffer in groups of pieces of data of a first size of data. Further, image data is read out in groups of pieces of data of a second size of data from among the image data having been written into the back buffer, and is transferred into a front buffer.

According to an embodiment of the present invention, it is possible to perform two series of control independently, one being a series of control performed for processes of writing image data into a back buffer, the other one being a series of control performed for processes of reading out image data from the back buffer.

### BRIEF DESCRIPTION OF THE DRAWINGS

FIGS. 1A, 1B and 1C are diagrams each illustrating an existing method for segmenting image data and writing the segmented image data into a front buffer for updating thereof;

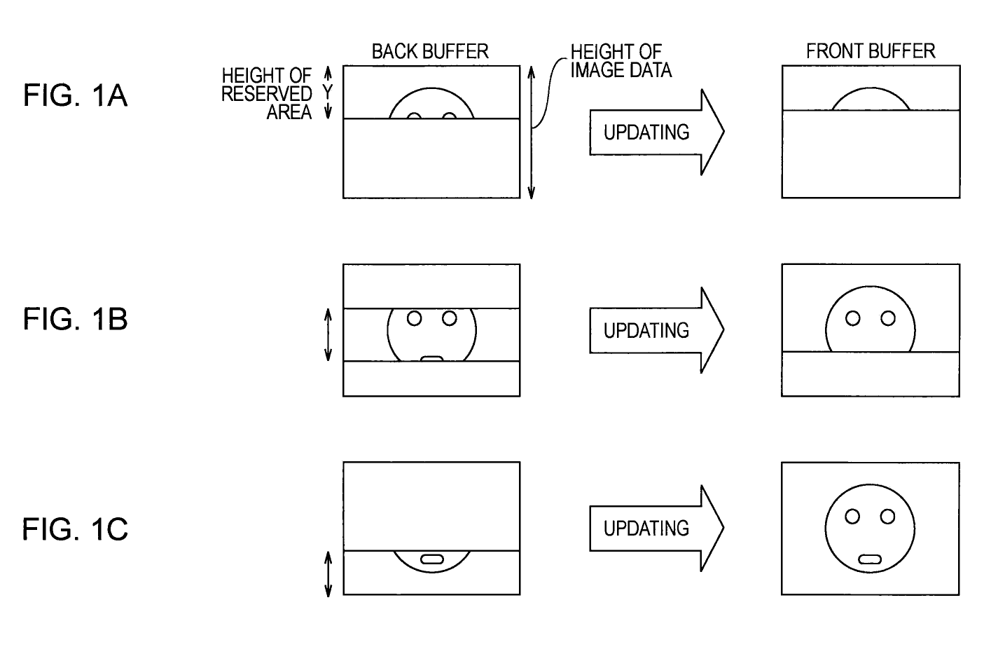

FIG. 2 is a diagram illustrating an existing method for segmenting image data and writing the segmented image data into a front buffer for updating thereof;

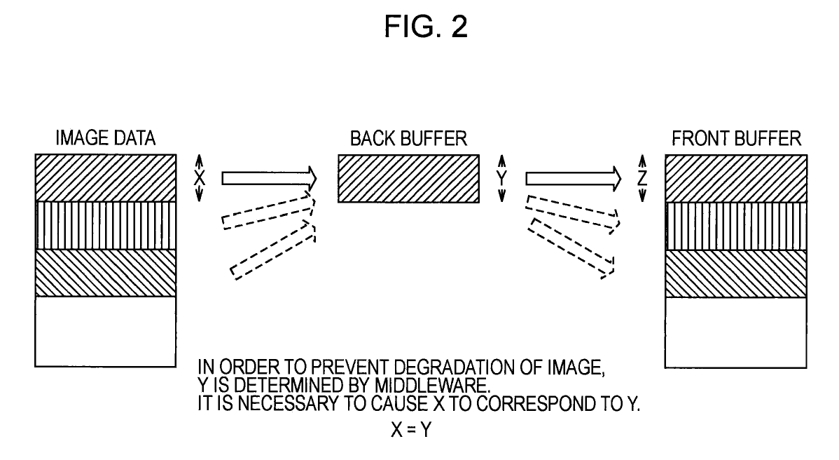

FIG. 3 is a block diagram illustrating a configuration of an example of an image display apparatus according to an embodiment of the present invention;

FIG. 4 is a diagram illustrating scopes of respective targets of control operations performed by an image viewer, which is an application program, and a buffer controller, which is a piece of middleware, according to an embodiment of the present invention;

FIG. 5 is a diagram illustrating arguments given to a buffer controller, which is a piece of middleware, according to an embodiment of the present invention;

FIGS. 6A and 6B are diagrams each illustrating an enlarging operation and a reducing operation of image data in updating of a front buffer, according to an embodiment of the present invention;

FIG. 7 is a diagram illustrating the number of lines X of each group of pieces of image data with which image data is written into a back buffer, and the number of lines Y of each group of pieces of image data with which image data is read out from a back buffer, according to an embodiment of the present invention;

FIGS. 8A and 8B are diagrams each illustrating an outline of operations performed in the case where a formula X≧Y is satisfied, according to an embodiment of the present invention;

FIGS. 9A and 9B are diagrams each illustrating an outline of operations performed in the case where a formula X<Y is satisfied, according to an embodiment of the present invention;

FIG. 10 is a flowchart illustrating processes performed by an image viewer, according to an embodiment of the present invention; and

FIG. 11 is a flowchart illustrating processes performed by a buffer controller, according to an embodiment of the present invention.

### DESCRIPTION OF THE PREFERRED EMBODIMENTS

Hereinafter, preferred embodiments (which will be hereinafter referred to as embodiments) will be described in detail with reference to drawings. In addition, this description will be made in an order as follows:

1. A first embodiment

An example of a configuration

Operations

### 1. A First Embodiment

### An Example of a Configuration of an Image Display Apparatus

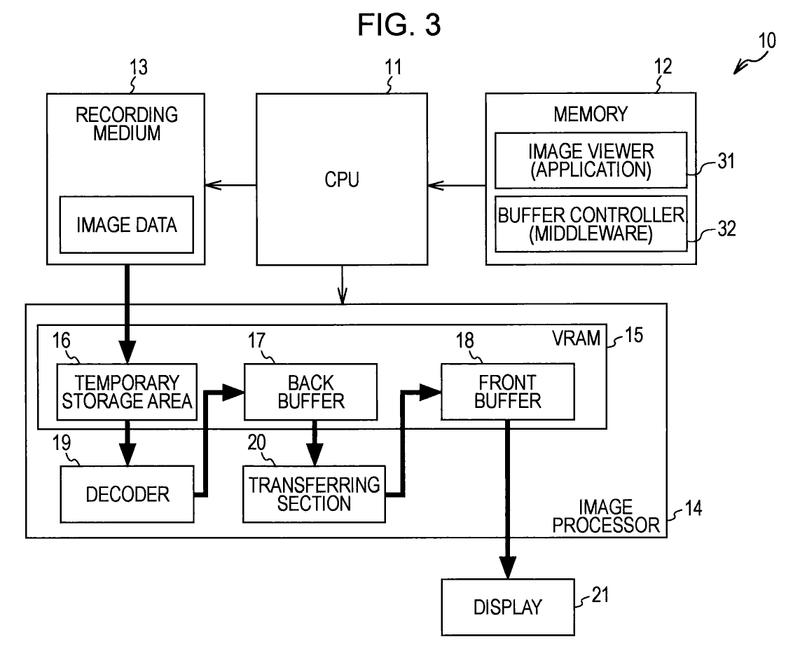

FIG. 3 is a diagram illustrating an example of a configuration of an image display apparatus according to an embodiment of the present invention. This image display apparatus 10 is incorporated into a device, such as a television receiver, and operates when performing processes with respect to image data recorded in a recording medium 13, such as a memory stick (which is a trademark of Sony corporation), and displaying images corresponding to the image data on a display 21, and the like.

The image display apparatus 10 includes a CPU 11, RAM 12, a recording medium 13 and an image processor 14.

The CPU 11 executes an image viewer 31, which is a application program recorded in the RAM 12, and thereby, performs control of a series of processes with respect to displaying images corresponding to image data recorded in the recording medium 13 on a display 21. In addition, the CPU 11 performs updating of a front buffer 18 by invoking application program interfaces (APIs) provided by a buffer controller 32, which is a piece of middleware.

The RAM 12 stores therein the image viewer (an application program) 31, which is executed by the CPU 11, and the buffer controller (a piece of middleware) 32, which provides a plurality of APIs invoked by the image viewer 31.

The recording medium 13 is realized by using a semiconductor memory device, such as a memory stick, and is configured to be attachable and detachable to/from the image display apparatus 10. The recording medium 13 includes pieces of image data recorded therein, which are compression-decoded by, for example, the JPEG method.

The image processor 14 includes therein VRAM 15, a decoder 19 and a transferring section 20.

The VRAM 15 includes therein a temporary storage area 16, a back buffer 17 and a front buffer 18. In the temporary storage area 16, pieces of compression-encoded image data which have been read out from the recording medium 13 are retained. Pieces of image data resulting from decoding (decompressing) of the pieces of compression-encoded image data are written into the back buffer 17. In addition, the size of the back buffer 17 will be hereinafter described. Pieces of image data transferred from the back buffer 17 are written into the front buffer 18, and images corresponding to the pieces of image data having been written thereinto are displayed on the display 21.

In accordance with control performed by the image viewer 31, the decoder 19 decodes pieces of compression-encoded image data retained in the temporary storage area 16, and outputs the resultant pieces of decoded image data to the back buffer in groups of X lines of pieces of image data extending in a vertical direction. It is possible to set this number of lines X independently from the number of lines Y of each group of pieces of image data extending in a vertical direction, with which image data is read out from the back buffer 17, and the number of lines Y will be described below. Therefore, it is possible to configure the decoder 19 by using hardware components which limit the number of lines X of each group of pieces of image data with which the decoder 19 is capable of outputting image data (for example, the number of lines X being limited to multiples of 36, or the like).

Obviously, the decoder 19 can be configured by using software components. However, it is expected that a decoding processing speed in the case where the decoder 19 is configured by using hardware components is increased to a greater degree than in the case where the decoder 19 is configured by using software components.

In accordance with control performed by the buffer controller 32, the transferring section 20 reads out pieces of image data having been written into the back buffer 17 in groups of pieces of image data including Y lines extending in a vertical direction, and writes the pieces of read-out image data into partitioned areas in the front buffer 18, each being capable of storing pieces of image data including Z lines therein (this operation will be hereinafter described in detail).

### DESCRIPTION OF OPERATIONS

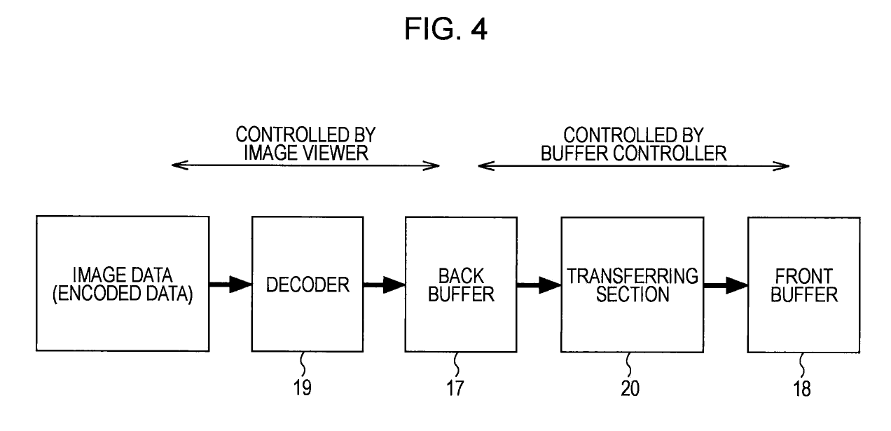

Next, FIG. 4 is a diagram illustrating respective sections which are targets of control operations performed by the image viewer 31 and the buffer controller 32.

The image viewer 31 performs control of processes executed by the image processer 14 so as to cause the image processer 14 to retain pieces of image data recorded in the recording medium 13 in the data temporary storage section 16, further, decode the retained pieces of image data, and write the resultant decoded pieces of image data into the back buffer 17 in groups of pieces of image data including X lines.

At the same time, the buffer controller 32 performs control of processes executed by the image processer 14 so as to cause the image processor 14 to read out pieces of image data from the back buffer 17 in groups of pieces of image data including Y lines, and write each read-out group of pieces of image data including Y lines into one of partitioned areas of the front buffer 18 for updating of thereof, the partitioned areas each being capable of storing pieces of image data including Z lines therein.

As described above, it is possible to perform control of two series of operations independently, one being a series of operations with respect to writing pieces of image data into the back buffer 17 in groups of pieces of image data including X lines, the other one being a series of operations with respect to reading out pieces of image data from the back buffer 17 in groups of pieces of image data including Y lines.

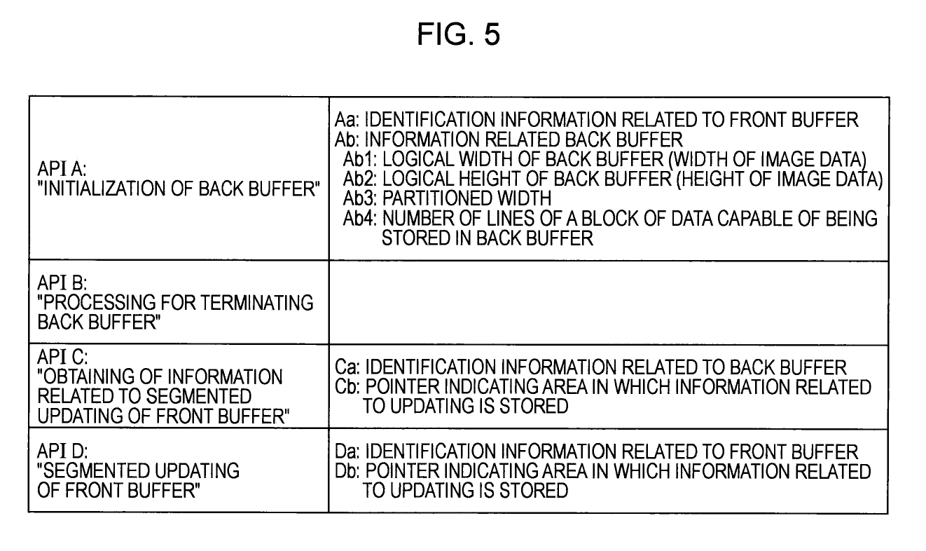

Next, FIG. 5 is a table representing four kinds of APIs provided by the buffer controller (a piece of middleware) 32, which are invoked by the image viewer 31.

API A is an application interface used for reserving a memory area in the back buffer 17 on the basis of an arguments Ab, which will be described below, and initializing management information related to the back buffer 17. The image viewer 31 specifies identification information related to the front buffer 18 (by an argument Aa) and back buffer related information (by the argument Ab). Moreover, it is possible to cause the back buffer related information to include a logical width (a width of a block of pieces of image data) of the back buffer 17 (by an argument Ab1), a logical height (a height of a block of pieces of image data) of the back buffer 17 (by an argument Ab2), a segmentation width (by an argument Ab3), and the number of lines of pieces of image data which can be stored in the back buffer 17 (by an argument Ab4).

API B is an application interface used for releasing the memory area in the back buffer 17 and clearing the management information related to the back buffer 17.

API C is an application interface used for obtaining information necessary to perform updating of the front buffer 18 corresponding to the back buffer 17 specified by an argument Ca, which will be described below, and storing the obtained information in an area specified by an argument Cb. More specifically, pieces of information regarding which area out of areas storing pieces of decoded image data therein, targeted pieces of image data are to be read out from, and which area of the back buffer 17, the read-out pieces of image data are to be written into, are stored in an area specified by the argument Cb. It is sufficient for the image viewer 31 to just perform updating of the back buffer 17 on the basis of these pieces of information, and invoking of API D, which will be subsequently described.

API D is an application interface used for updating the front buffer 18 on the basis of an argument Da, which will be described below. More specifically, subsequent to completion of segmented updating of the front buffer 18 specified by an argument Da, which will be described below, pieces of information necessary to perform a subsequent updating of the front buffer 18 are stored in an area specified by an argument Db. It is sufficient for the image viewer 31 to just iterate processes of updating the back buffer 17 on the basis of obtained pieces of information and processes of invoking API D until completion of segmented updating of the front buffer 18 specified by the argument Da.

In addition, the foregoing API A is an example provided on the assumption that necessary information related to the front buffer 18 (a logical size of width, a logical size of height, a memory address of an area for storing image data, and the like) can be obtained via different pieces of middleware on the basis of identification information related to the front buffer 18. In the case where the different pieces of middleware do not exist, more arguments are added to the present arguments of the API A so that the image viewer 31 can also specify the information related to the front buffer 18 (the logical size of width, the logical size of height, the memory address of an area for storing image data, and the like).

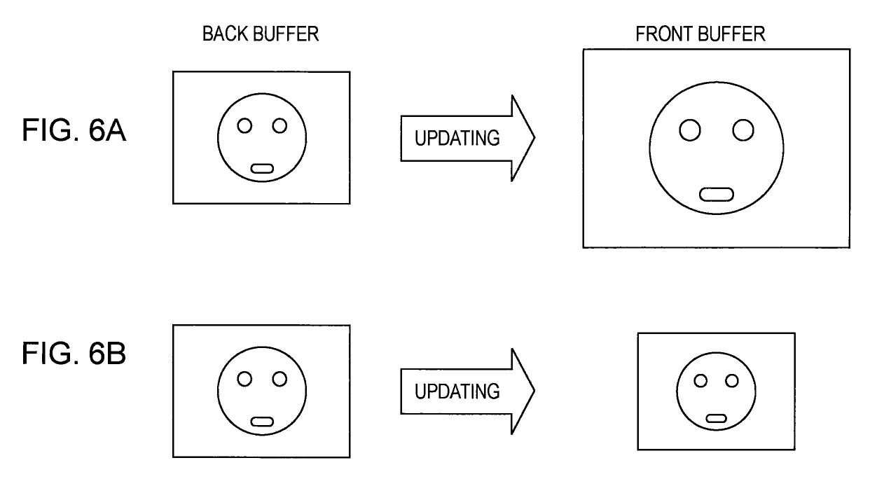

Next, FIG. 6 is a diagram illustrating an outline of enlarging and reducing operations performed during a procedure in which pieces of image data are written into the front buffer 18.

Enlarging or Reducing

In the case where logical sizes of width and height of the back buffer 17 specified by arguments Ab1 and Ab2 of API A are different from logical sizes of width and height of the front buffer 18, pieces of image data stored in the back buffer 17 are enlarged or reduced, and the resultant enlarged or reduced pieces of image data are written into the front buffer 18 for updating thereof.

For example, in the case where logical sizes of width and height of the back buffer 17 are smaller than logical sizes of width and height of the front buffer 18, as shown in FIG. 6A, pieces of image data stored in the back buffer 17 are enlarged, and the resultant enlarged pieces of image data are written into the front buffer 18 for updating thereof.

For example, in the case where logical sizes of width and height of the back buffer 17 are larger than logical sizes of width and height of the front buffer 18, as shown in FIG. 6B, pieces of image data stored in the back buffer 17 are reduced, and the resultant reduced pieces of image data are written into the front buffer 18 for updating thereof.

Therefore, changing of the logical sizes of width and height of the front buffer 18 performed by the image viewer 31 enables enlarging or reducing of the sizes of images to be displayed on the display 21. An enlargement ratio (a reduction ratio) is determined by the logical sizes of width and height of the back buffer 17 and the logical sizes of width and height of the front buffer 18, and thus, the enlargement ratio (the reduction ratio) varies in accordance with the changing of the logical sizes of width and height of the front buffer 18.

Therefore, every time the updating of the front buffer 18 is performed, the logical sizes of width and height of the front buffer 18 are obtained to calculate an enlargement ratio (a reduction ratio) therefrom. In this way, even though the logical sizes of width and height of the front buffer 18 are changed, every time the updating of the front buffer 18 is performed, from the logical sizes of width and height of the front buffer 18 and the logical sizes of width and height of the back buffer 17 as of then, the enlargement ratio (the reduction ratio) can be obtained. Therefore, although the logical sizes of width and height of the front buffer 18 are changed, updating of the front buffer 18 can be performed without changing the settings of the back buffer 17, that is, in the same manner as that before the changing of logical sizes of width and height of the front buffer 18.

Next, an outline of operations performed in the case where the back buffer 17 is used as a ring buffer will be described.

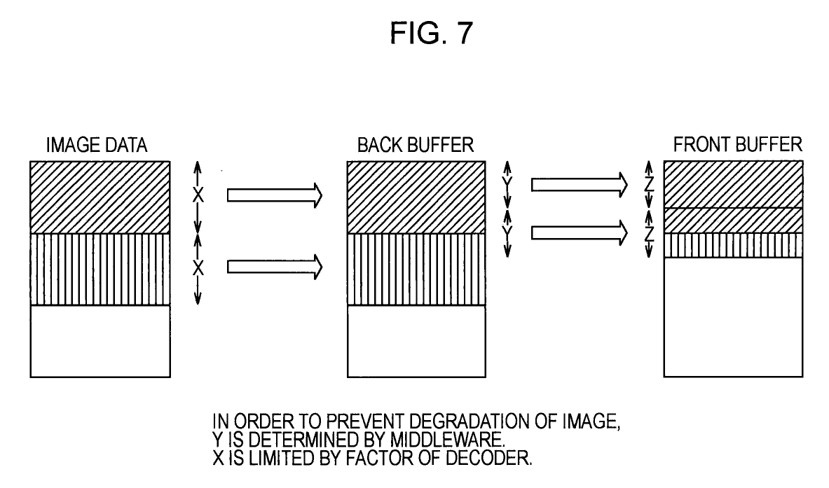

As shown in FIG. 7, as described above, in order to suppress degradation of images due to performing updating of the front buffer 18, the number of lines Y of each group of pieces of image data with which image data is read out from the back buffer 17 is determined by the buffer controller 32, which is a piece of middleware, on the basis of the number of lines Z, which is the number of lines of pieces of image data which can be stored in each of partitioned areas reserved in the front buffer 18.

In contrast, in the case where the decoder 19, which is a source from which pieces of image data originate, is configured by using hardware components, the number of lines X of each group of pieces of image data with which the decoder 19 is capable of outputting image data is limited to, for example, multiples of 32, and the like.

In this regard, as described above, even though there are limitations on the number X of lines of each group of pieces of image data with which image data is written into the back buffer 17, and the number Y of lines of each group of image data with which image data is read out from the back buffer 17, respectively, provided that a memory space having a sufficiently large storage capacity can be reserved as the back buffer 17, it is sufficient to just make a rate of reading out image data from the back buffer 17 less than or equal to a rate of writing image data into the back buffer 17.

However, since there is a limitation on a memory space reserved as the back buffer 17, it is necessary to appropriately perform control of operations for writing and reading out image data into/from the back buffer 17.

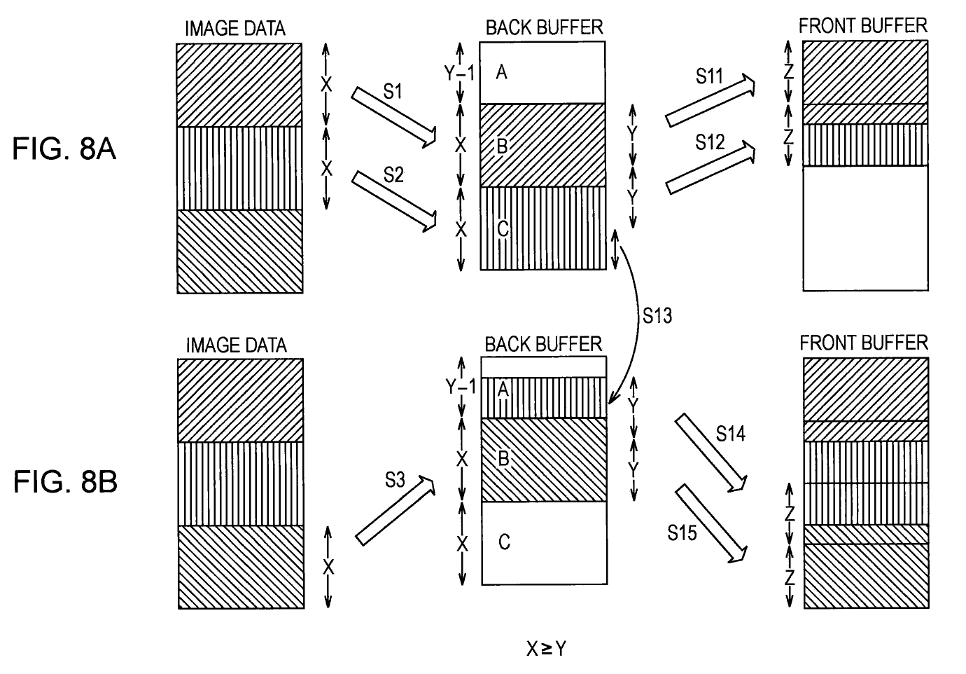

FIG. 8 is a diagram illustrating an outline of control of operations for writing and reading out image data when using the back buffer 17 as a ring buffer, in the case where a formula X≧Y is satisfied.

More specifically, handling is performed so that at least three areas A, B and C are provided, and as the first area A, an area having the storage capacity of (Y-1) lines of image data is reserved. Further, as each of the areas B, C and the like subsequent to the first area A, an area having the storage capacity of X lines of image data is reserved.

As described above, operations for writing image data into the back buffer 17 are performed by the decoder 19 in accordance with control performed by the image viewer 31. Further, operations for reading out image data from the back buffer 17 are performed by the data transferring section 20 in accordance with control performed by the buffer controller 32.

One of the two series of operations described above, that is, the operations for writing pieces of image data into the back buffer 17 are performed for the areas excluding A, that is, B and C, in such an order as follows: B, C, B, C . . . . That is, during step S1, pieces of decoded image data included in a first segment including X lines are written into the area B, and during step S2, pieces of decoded image data included in a second segment including X lines are written into the area C. Further, subsequent to completion of reading out pieces of decoded image data included in the first segment, which have been written into the area B, pieces of decoded image data included in a third segment including X lines are written into the area B during step S3.

The other one of the two series of operations described above, that is, the operations for reading out pieces of image data from the back buffer 17 are performed in the same order as the order in which the pieces of image data have been written into the back buffer 17, that is, pieces of image data are read out, firstly, from the area B, and subsequently, from the area C. In addition, since the reading out of image data from the back buffer 17 at one time is successively performed for all the pieces of image data including Y lines, in the case where pieces of image data including less than Y lines remain left in the last area (i.e., the area C), the pieces of image data including less than Y lines are transferred to a backmost portion of the area A. Further, pieces of image data including Y lines are successively read out from the area A, and then, from the area B.

That is, during step S11, from among the pieces of image data included in the first segment including X lines, which have been written into the area B of the back buffer 17, pieces of image data including Y lines are read out, and then, are written into the front buffer 18 for updating thereof. Subsequently, during step S12, pieces of image data including Y lines resulting from connection of the remaining pieces of image data including m lines out of the pieces of image data included in the first segment including X lines, which have been written into the area B, and pieces of image data including (Y-m) lines out of the pieces of image data included in the second segment including X lines, which have been written into the area C, are read out, and then, are written into the front buffer 18 for updating thereof.

Subsequently, although certain pieces of image data (which have not yet been read out) out of the pieces of image data included in the second segment including X lines remain left in the area C of the back buffer 17, the remaining pieces of image data are of a size of image data including less than Y lines, and thus, are transferred to a backmost portion in the area A during step S13. Subsequently, during step S14, pieces of image data including Y lines resulting from connection of the remaining pieces of image data including n lines less than Y lines, which have been transferred to the backmost portion in the area A of the back buffer 17, and pieces of image data including (Y-n) lines out of the pieces of image data included in the third segment including X lines, which have been written into the area B, are read out, and then, are written into the front buffer 18 for updating thereof.

Furthermore, during step S15, the remaining pieces of image data out of the pieces of image data included in the third segment including X lines, which have been written into the area B, are read out, and then, are written into the front buffer 18 for updating thereof.

As described above, in the case where the formula X≧Y is satisfied, the usage of the back buffer 17 as a ring buffer enables control of two series of operations to be performed independently, and further, enables the two series of operations to be executed concurrently, one of the two series of operations being operations for writing image data into the back buffer 17, and the other one of the two series of operations being operations for reading out image data from the back buffer 17.

In addition, in order to execute the two series of operations concurrently, it is necessary to provide one area having a storage capacity of image data including (Y-1) lines and two or more areas each having a storage capacity of image data including X lines in the back buffer 17.

Further, in the back buffer 17, four or more areas, that is, areas D, E, . . . , each reserving a storage capacity of image data including X lines, in addition to the areas A, B and C, may be provided. In this case, pieces of image data are written into the back buffer 17 in an order as follows: B, C, D, E, B, C, D, E, . . . .

In contrast, only two areas A and B may be provided in the back buffer 17. In this case, it is also possible to perform control of the two series of operations independently, one being operations for writing image data into the back buffer 17, the other one being operations for reading out image data from the back buffer 17. However, in this case, it is difficult to execute the two series of operations concurrently.

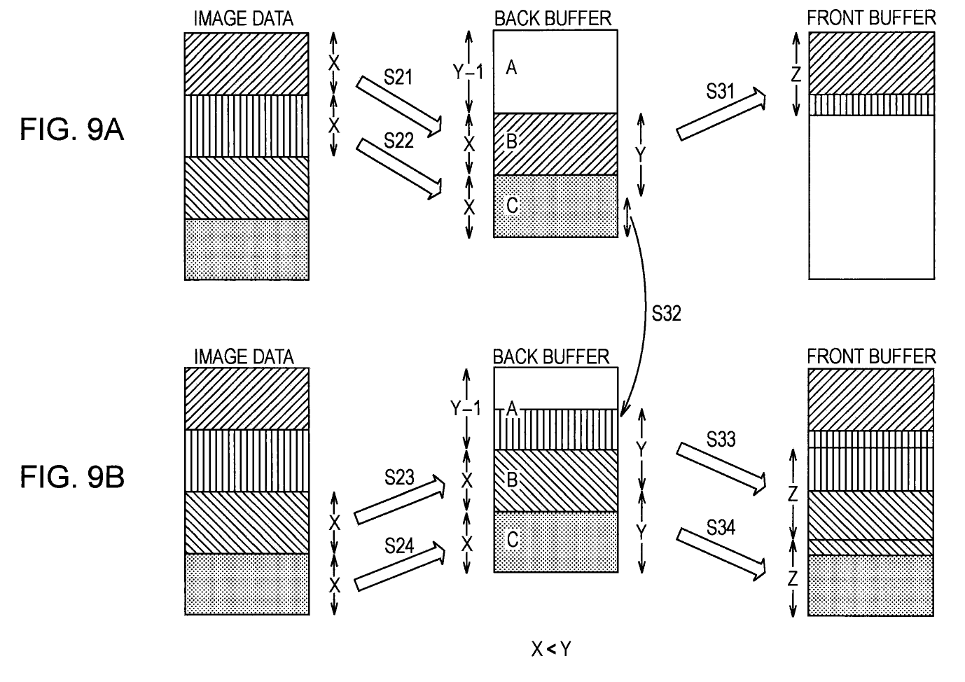

Next, FIG. 9 is a diagram illustrating an outline of control of operations for writing and reading out image data when using the back buffer 17 as a ring buffer, in the case where a formula X<Y is satisfied.

Areas to be provided in the back buffer 17 are the same as those, shown in FIG. 8, in the case where the formula X≧Y is satisfied, and therefore, descriptions of the areas are omitted here.

One of the two series of operations, that is, the operations for writing pieces of image data into the back buffer 17 are performed for the areas excluding A, that is, B and C, in such an order as follows: B, C, B, C . . . . That is, during step S21, pieces of decoded image data included in a first segment including X lines are written into the area B, and during step S22, pieces of decoded image data included in a second segment including X lines are written into the area C. Further, subsequent to completion of reading out pieces of decoded image data included in the first block, which have been written into the area B, pieces of decoded image data included in a third segment including X lines are written into the area B during step S23. Further, subsequent to completion of reading out of the pieces of image data which have been written into the area C, pieces of image data included in a fourth block including X lines are written into the area C during step S24.

The other one of the two series of operations, that is, the operations for reading out pieces of image data from the back buffer 17 are performed in the same order as an order in which the pieces of image data have been written into the back buffer 17, that is, pieces of image data are read out, firstly, from the area B, and subsequently, from the area C. In addition, since the reading out of image data from the back buffer 17 at one time is successively performed for all the pieces of image data including Y lines, in the case where pieces of image data including less than Y lines remain left in the last area (i.e., the area C), the remaining pieces of image data including less than Y lines are transferred to a backmost portion of the area A. Further, pieces of image data including Y lines are successively read out from the area A, and then, from the area B.

That is, during step S31, pieces of image data including Y lines resulting from connection of pieces of image data including p lines out of the pieces of image data included in the first segment including X lines, which have been written into the area B, and pieces of image data including (Y-p) lines out of the pieces of image data included in the second segment including X lines, which have been written into the area C, are read out, and then, are written into the front buffer 18 for updating thereof.

Subsequently, although certain pieces of image data (which have not yet been read out) out of the pieces of image data included in the second segment including X lines remain left in the area C of the back buffer 17, the remaining pieces of image data are of a size of image data including less than Y lines, and thus, are transferred to a backmost portion in the area A during step S32. Subsequently, during step S33, pieces of image data including Y lines resulting from connection of the remaining pieces of image data including q lines less than Y lines, which have been transferred to the backmost portion in the area A of the back buffer 17, and pieces of image data including (Y-q) lines out of the pieces of image data included in the third segment including X lines, which have been written into the area B, are read out, and then, are written into the front buffer 18 for updating thereof.

Furthermore, during step S34, pieces of image data including Y lines resulting from connection of the remaining pieces of image data including r lines out of the pieces of image data included in the third segment including X lines, which have been written into the area B, and pieces of image data including (Y-r) lines out of the pieces of image data included in the fourth segment in the area C, which have been written into the area C, are read out, and then, are written into the front buffer 18 for updating thereof.

As described above, also in the case where the formula X<Y is satisfied, the usage of the back buffer 17 as a ring buffer enables control of two series of operations to be performed independently, and further, enables the two series of operations to be executed concurrently, one of the two series of operations being operations for writing image data into the back buffer 17, and the other one of the two series of operations being operations for reading out image data from the back buffer 17.

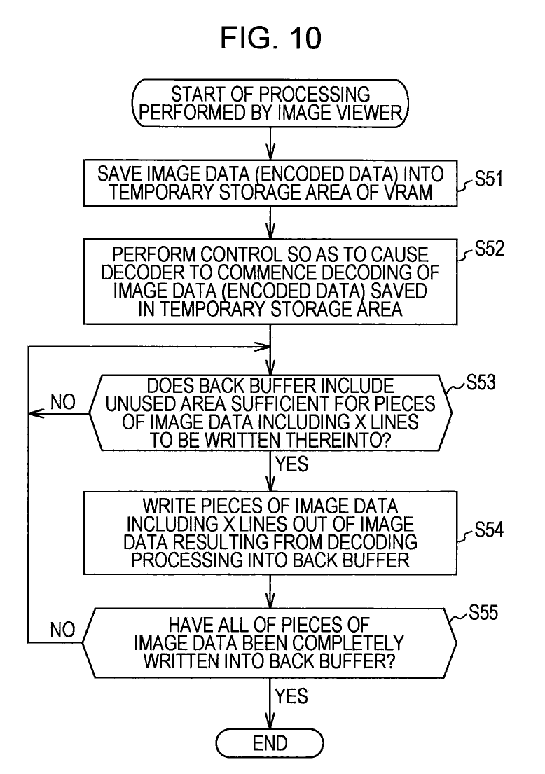

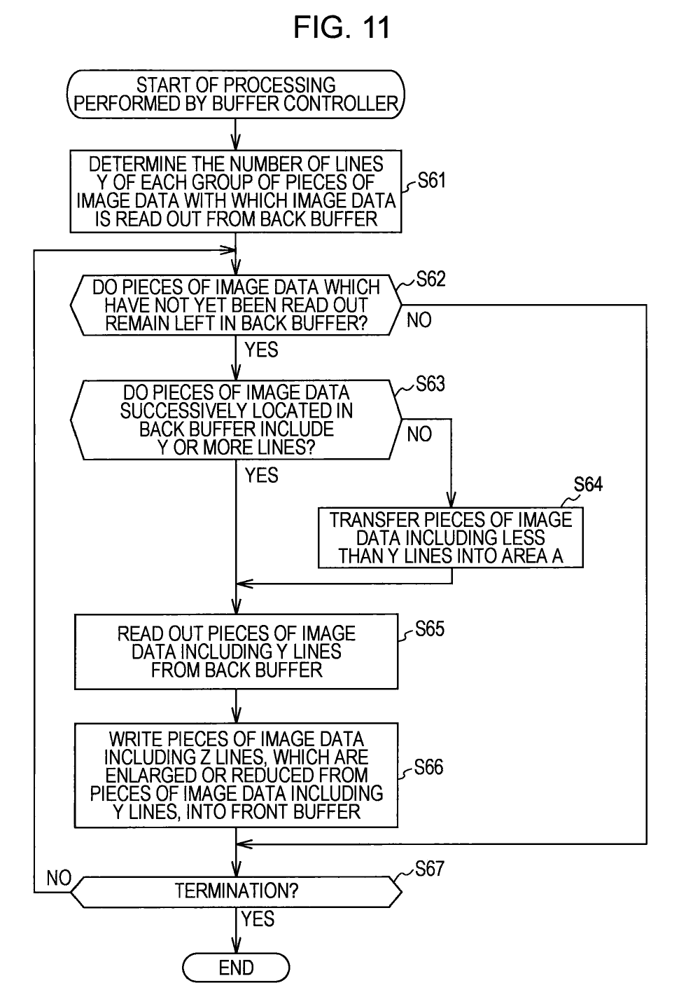

Next, the control of operations for writing and reading out of image data when using the back buffer 17 as a ring buffer, which have been outlined with reference to FIGS. 8 and 9, will be described with reference to FIGS. 10 and 11.

FIG. 10 is a diagram illustrating a flowchart of processes performed by the image viewer 31 with respect to control of operations for writing image data into the back buffer 17.

During step S51, the image viewer 31 causes pieces of image data, being recorded in the recording medium 31 and not having been subjected to decoding processing, to be retained in the temporary storage area 16 of the VRAM 15. During step S52, the image viewer 31 performs control so as to cause the decoder 19 to commence decoding of the pieces of image data retained in the temporary storage area 16.

During step S53, the image viewer 31 determines whether the back buffer 17 has a space (for example, the area B or the area C shown in FIG. 8 or FIG. 9) sufficient for pieces of image data including X lines to be written thereinto, or not, and in the case where the back buffer 17 has no space, the image viewer 31 waits for an available space until it can acquire the space. Further, once the image viewer 31 determines that the back buffer 17 has a space sufficient for pieces of image data including X lines to be written thereinto, the image viewer 31 causes the flow of processing to proceed to step S54. During step S54, the image viewer 31 causes the decoder 19 to write pieces of image data including X lines from among pieces of image data resulting from decoding processing into the space in the back buffer 17, which is capable of storing the pieces of image data including X lines therein.

During step S55, the image viewer 31 determines whether all the pieces of image data decoded by the decoder 19 have been completely written into the back buffer 17, or not. Further, the image viewer 31 returns the flow of processing to step S53, and iterates the following processes performed during steps S53 to S55 until it is determined that all the pieces of image data decoded by the decoder 19 have been completely written into the back buffer 17. Further, once it is determined that all the pieces of image data decoded by the decoder 19 have been completely written into the back buffer 17, the image viewer 31 notifies the buffer controller 32 of the completion, and then, terminates the flow of processing.

Next, FIG. 11 is a diagram illustrating a flowchart of processes performed by the buffer controller 32 with respect to control of operations for reading out image data which has been written into the back buffer 17.

During step S61, the buffer controller 32 determines the number of lines Y of each group of pieces of image data with which image data is read out from the back buffer 17, on the basis of an enlargement ratio or a reduction ratio of image data and the number of lines Z, which is the number of lines of pieces of image data which can be stored in each of partitioned areas reserved in the front buffer 18.

During step S62, the buffer controller 32 determines whether, among pieces of image data which have been written into the back buffer 17, pieces of image data, which have not yet been read out, remain left, or not. During step S63, in the case where it is determined that pieces of image data, which have not yet been read out, remain left, the flow is caused to proceed to step S63. In contrast, in the case where it is determined that any pieces of image data which have not yet been read out do not remain left, the flow is caused to proceed to step S67.

During step S63, the buffer controller 32 determines whether pieces of image data successively located in the back buffer 17 include Y lines or more, or not. During step S63, it is determined that the pieces of image data successively located in the vertical direction 17 do not include Y lines or more, the flow is caused to proceed to step S64. During step S64, the buffer controller 32 performs control so as to cause the transferring section 20 to transfer the pieces of image data including less than Y lines into a backmost portion of the area A.

In addition, during step S63, in the case where it is determined that the pieces of image data successively located in the back buffer 17 include Y lines or more, the flow is caused to skip step S64 and proceed to step S65.

During step S65, the buffer controller 32 performs control so as to cause the transferring section 20 to read out the pieces of image data including Y lines, further, perform converting (enlarging or reducing) of the read-out pieces of image data into pieces of image data including Z lines, and then, write the converted pieces of image data into the front buffer 18.

During step S67, the buffer controller 32 determines whether the processing is to be terminated, or not, on the basis of existence or nonexistence of a notification of termination from the image viewer 31. More specifically, in the case where there is no notification of termination from the image viewer 31, the buffer controller 32 returns the flow of processing to step S62, and iterates subsequent processes. Subsequently, upon receipt of a notification of termination from the image viewer 31, the buffer controller 32 terminates the processing described above.

As described above, the image viewer 31 and the buffer controller 32 are capable of suppressing increase of the size of a memory space of the VRAM 15, which is used as the back buffer 17, and further, performing control of two series of operations independently, one being operations for writing image data into the back buffer 17, the other one being operations for reading out image data from the back buffer 17. Furthermore, the image viewer 31 and the buffer controller 32 are capable of executing two series of operations concurrently, one being operations for writing pieces of image data including X lines into the back buffer 17, and the other one being operations for reading out pieces of image data including Y lines from the back buffer 17.

Further, writing pieces of image data into the back buffer 17 and the front buffer 18 for updating thereof on a segment-by-segment basis makes it unnecessary to wait for completion of decoding processes with respect to all the pieces of image data, and allows users to be aware of a condition in which a targeted image is sequentially displayed on a section-by-section basis, and easily grasp the progress of the decoding processes. Therefore, even though, due to increasing of image resolution, it takes a large amount of time to complete decoding processes with respect to image data to a greater degree, this method can relieve user's stress due to a waiting time before commencement of displaying a desired image on a display device.

Moreover, if necessary, it is possible to provide users with an option which allows ceasing of displaying a targeted image prior to completion of decoding processes (however, it depends on functions of a user interface included in the image viewer 31 whether this option is available, or not).

The present application contains subject matter related to that disclosed in Japanese Priority Patent Application JP 2008-302339 filed in the Japan Patent Office on Nov. 27, 2008, the entire content of which is hereby incorporated by reference.

It should be understood by those skilled in the art that embodiments of the present invention are not limited to the foregoing embodiment, but various modifications are conceivable within the scope not departing from the gist of the present invention.

What is claimed is:

1. A display control apparatus causing an image corresponding to image data having been written into a front buffer to be displayed on a display device, the display control apparatus comprising:
decoding means for decoding encoded image data and writing image data resulting from decoding of the encoded image data into a back buffer in groups of pieces of data of a first size of data; and
transferring means for reading out image data in groups of pieces of data of a second size of data from among the image data, having been written into the back buffer in groups of pieces of data of the first size of data, and transferring the read-out image data into the front buffer;
wherein the back buffer is a ring buffer including a buffering area resulting from connection of a secondary area having a storage capacity determined on the basis of the second size of data and a plurality of primary areas each having a storage capacity at least the same as the first size of data.

2. The display control apparatus according to claim 1, wherein the transferring means reads out image data in groups of pieces of data of the second size of data from among the image data having been written into the primary areas of the back buffer and including successively located pieces of image data, the size of which is more than or equal to the second size of data, and transfers the read-out image data into the front buffer.

3. The display control apparatus according to claim 2, wherein, in the case where the image data having been written into the primary areas of the back buffer includes successively located pieces of image data, the size of which is less than the second size of data, the transferring means transfers the image data including successively located pieces of image data, the size of which is less than the second size of data, into a backmost portion of the secondary area, and reads out image data in groups of pieces of data of the second size of data from among the image data, having been written into the secondary area and the primary areas, and including successively located pieces of image data, the size of which is more than or equal to the second size of data, and transfers the read-out image data into the front buffer.

4. The display control apparatus according to claim 2, wherein the transferring means reads out image data in groups of pieces of data of the second size of data from among the image data, having been written into the back buffer in groups of pieces of data of the first size of data, further, converts the read-out image data into image data of a third size of data, and transfers the converted image data into the front buffer.

5. The display control apparatus according to claim 2, wherein the decoding means is controlled by an application program, and the transferring means is controlled independently from the application program by middleware invoked by the application program.

6. A display control method included in a display control apparatus causing an image corresponding to image data having been written into a front buffer to be displayed on a display device, the display control apparatus comprising the steps of:
decoding encoded image data;
writing image data resulting from decoding of the encoded image data into a back buffer in groups of pieces of data of a first size of data;
reading out image data in groups of pieces of data of a second size of data from among the image data having been written into the back buffer in groups of pieces of data of the first size of data; and
transferring the read-out image data into the front buffer;
wherein the back buffer is a ring buffer including a buffering area resulting from connection of a secondary area having a storage capacity determined on the basis of the second size of data and a plurality of primary areas each having a storage capacity at least the same as the first size of data.

7. A program performing control of a display control apparatus which causes an image corresponding to image data having been written into a front buffer to be displayed on a display device, the program causing a computer included in the display control apparatus to execute a process comprising the steps of:
decoding encoded image data;
writing image data resulting from decoding of the encoded image data into a back buffer in groups of pieces of data of a first size of data;
reading out image data in groups of pieces of data of a second size of data from among the image data having been written into the back buffer in groups of pieces of data of the first size of data; and
transferring the read-out image data into the front buffer;
wherein the back buffer is a ring buffer including a buffering area resulting from connection of a secondary area having a storage capacity determined on the basis of the second size of data and a plurality of primary areas each having a storage capacity at least the same as the first size of data.

8. A display control apparatus causing an image corresponding to image data having been written into a front buffer to be displayed on a display device, the display control apparatus comprising:
a decoder configured to decode encoded image data and write image data resulting from decoding of the encoded image data into a back buffer in groups of pieces of data of a first size of data; and
a transferring section configured to read out image data in groups of pieces of data of a second size of data from among the image data having been written into the back buffer in groups of pieces of data of the first size of data, and transfer the read-out image data into the front buffer;
wherein the back buffer is a ring buffer including a buffering area resulting from connections of a secondary area having a storage capacity determined on the basis of the second size of data and a plurality of primary areas each having a storage capacity at least the same as the first size of data.
